(19) United States
(12) Patent Application Publication
(10) Pub. No.: US 2010/0132047 A1
(43) Pub. Date: May 27, 2010

(54) SYSTEMS AND METHODS FOR TAMPER RESISTANT MEMORY DEVICES

(75) Inventors: Manuel I. Rodriguez, St. Petersburg, FL (US); Jamal Haque, Clearwater, FL (US); Keith A. Souders, Tampa, FL (US)

Correspondence Address: HONEYWELL/S&S;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/276,940

(22) Filed: Nov. 24, 2008

(51) Int. Cl. G06F 12/14

(52) U.S. Cl. 726/27

(57) ABSTRACT

Systems and methods for tamper resistant memory devices are provided. In one embodiment, a memory device comprises a memory cell for storing digital data, the memory cell having a plurality of memory addresses accessible for read and write operations through a memory interface; and a tamper detection circuit coupled to the memory cell, the tamper detection circuit comprising: a communications decoder coupled to the memory interface, wherein the communications decoder observes sequences of memory access operations to the memory cell; at least one timer for counting a duration of time; a tamper detect state machine responsive to the communications decoder and the at least one timer; and a data destruct engine responsive to the tamper detection state machine, wherein upon receiving an activation signal from the tamper diction state machine, the data destruct engine overwrites digital data stored in the memory cell.

### BACKGROUND

Tamper-resistant designs are necessary for the protection of critical technology against exploitation either by use or by reverse engineering. Electronic systems that use memory devices such as microprocessors, micro controllers, or re-configurable field programmable gate arrays (FPGAs) can be reverse-engineered by competing and adversarial groups by examining the contents, both data and algorithms, stored by the memory devices.

For the reasons stated above and for other reasons stated below which will become apparent to those skilled in the art upon reading and understanding the specification, there is a need in the art for tamper resistant memory devices.

### SUMMARY

The Embodiments of the present invention provide methods and systems for tamper resistant memory devices and will be understood by reading and studying the following specification.

Systems and methods for tamper resistant memory devices are provided. In one embodiment, a memory device comprises a memory cell for storing digital data, the memory cell having a plurality of memory addresses accessible for read and write operations through a memory interface; and a tamper detection circuit coupled to the memory cell, the tamper detection circuit comprising: a communications decoder coupled to the memory interface, wherein the communications decoder observes sequences of memory access operations to the memory cell; at least one timer for counting a duration of time; a tamper detect state machine responsive to the communications decoder and the at least one timer; and a data destruct engine responsive to the tamper detection state machine, wherein upon receiving an activation signal from the tamper diction state machine, the data destruct engine overwrites digital data stored in the memory cell.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a tamper resistant memory device of one embodiment of the present invention;

FIG. 2 is a block diagram illustrating a system comprising a tamper resistant memory device of one embodiment of the present invention;

FIG. 3 is a block diagram illustrating a plurality of daisy-chained tamper resistant memory devices of one embodiment of the present invention; and

FIG. 4 is a flow chart illustrating a method for providing tamper resistant memory of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide an electronic tamper-resistant barrier to help prevent the exploitation (either by use or by reverse engineering) of a system by a competing or otherwise adversarial party. Embodiment of the present invention provide a design for a memory device such as a random access memory (RAM) or electrically erasable programmable read only memory (EEPROM) that comprises the ability to destruct, under a predefined set of circumstances, the contents stored within it's memory cells. This inhibits the ability for an adversarial party to inspect or otherwise exploit the contents of the memory device.

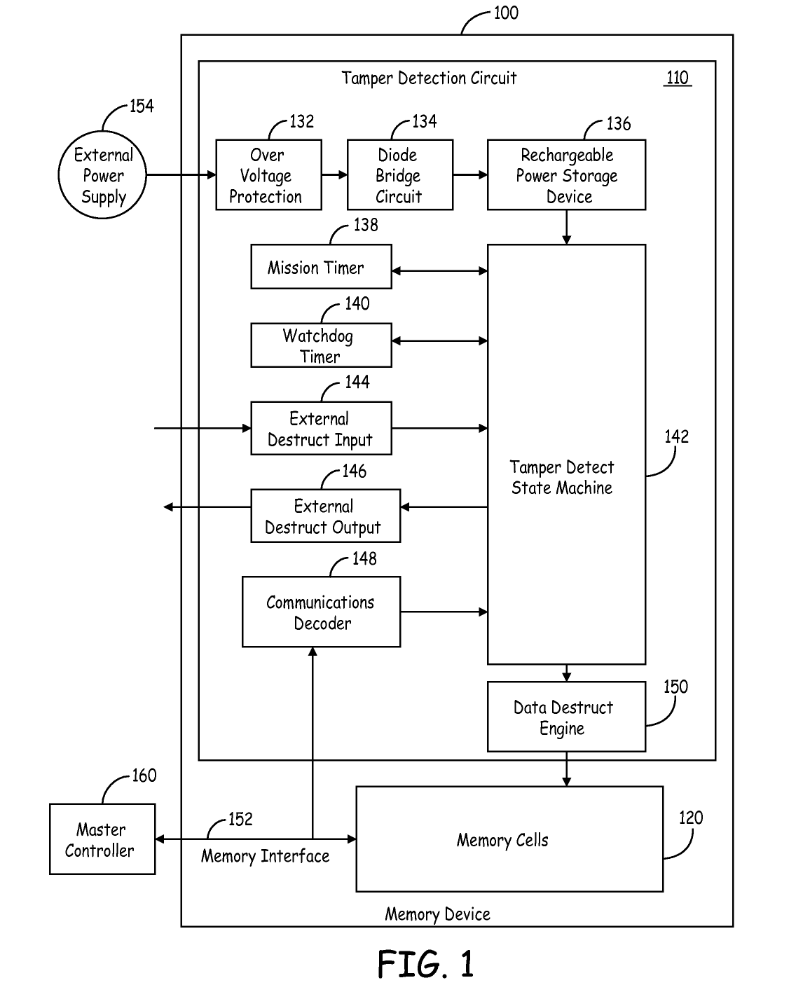

FIG. 1 is a block diagram illustrating a tamper resistant memory device 100 of one embodiment of the present invention. Memory device 100 comprises a tamper detection circuit 110 coupled to one or more memory cells 120. Memory cells 120 comprise one or more devices for receiving and saving digital data from a master controller, and storing the digital data so that it may be retrieved by the processing system. Master controller 160 may comprise a microprocessor, microcontroller, Field Programmable Gate Array (FPGA) or other processing device. The digital data may include, but is not limited to programming instruction code, code for an FPGA, sampled sensor data, computational results, temporary buffer data, or any other type of data. Memory cells 120 include a memory interface 152 having address, data and control lines for providing read and write access to memory cells 120. In one implementation, the address and data lines provide data access lines for saving digital data to specific memory addresses and retrieving data from specific memory addresses. Control lines handle operational functions such as indicating whether a current memory access request is a read or a write operation. One of ordinary skill in the art upon reading this specification would appreciate that embodiments of the present invention are not limited to a specific technology used to implement memory cells 120 but may include any technology that allows random or sequential access to stored digital data.

Memory cells 120 comprise normal memory technologies that one of ordinary skill in the art would expect to use for storing digital data. In one embodiment, from the operational perspective of the master controller 140 or any other device coupled to memory interface 152 and utilizing memory device 100 for data storage and retrieval, memory cells 120 appear to operate like any memory device—any standard RAM with data, address, and read/write control lines. That is, from the perspective of the memory interface 152, memory device 100 appears like a standard memory device.

Tamper detection circuit 110 comprises a tamper detect state machine 142 coupled to a data destruct engine 150. Data destruct engine 150 operates to obfuscate digital data stored in memory cells 120 when instructed to do so by tamper detect state machine 142. This process is explained in greater detail below. As shown in FIG. 1, tamper detect state machine 142 is also coupled to a mission timer 138, a watchdog time 140, an external destruct input 144, and external destruct output 146, and a communications decoder 148. Tamper detect state machine 142 is powered by a rechargeable power storage device 136. Rechargeable power storage device 136 is coupled to an external power supply 154. In the embodiment shown in FIG. 1, rechargeable power storage device 136 is protected by an over voltage protection circuit 132 and a diode bridge circuit 134 which prevents external draining of rechargeable power storage device 136.

Data destruct engine 150 performs a data overwrite function to obliterate part, or all, of the digital data stored in memory cell 120. Upon activation, data destruct engine 150 blocks any further read or write access to memory cells 120. In one embodiment, data destruct engine 150 blocks access to memory cells 120 by shorting or otherwise disabling memory interface 152. Data destruct engine 150 overwrites some or all of the digital data stored in memory cells 120 by writing zero, ones or random data to memory cells 120. In one embodiment, data destruct engine writes over the digital data with dummy data. That is, in one embodiment data destruct engine 150 replaces digital data stored in memory cells 120 with bogus data that is intended to mislead the tampering party attempting to read data from memory device 100. For example, in one embodiment, instruction code stored in memory cells 120 is replaced with bogus instruction code to mislead the intruder regarding the purpose or capabilities of functions performed by the master controller 160. In another embodiment, data destruct engine 150 replaces actual sensor measurement data with erroneous data that appears to be sensor measurement data. In one embodiment, rather that obliterating all digital data from memory cells 120, data destruct engine 150 performs a targeted overwrite, only targeting certain areas (memory addresses) of memory cell 120. Doing so reduces the amount of time rechargeable power storage device 136 must power circuit 110 upon a loss of power. In one embodiment, data destruct engine 150 deletes data from memory cells 120 based on a priority lists, erasing the most sensitive data first before proceeding to relatively less sensitive data.

Rechargeable power storage device 136 maintains power to tamper detection circuit 110. In one embodiment rechargeable power storage device 136 comprises a rechargeable chemical battery. In alternate embodiments, rechargeable power storage device 136 comprises a capacitive energy storage device. Rechargeable power storage device 136 only needs to supply power for just enough time for tamper detect state machine 142 to activate data destruct engine 150, and for data destruct engine 150 to overwrite digital data in memory cell 120.

Tamper Detect State Machine 142 provides the logic for deciding when to activate data destruct engine 150 based on inputs from communication decoder 148, external destruct input 144, watchdog timer 140 and mission timer 138. In one embodiment, tamper detect state machine 142 also resets and reprograms one or both of mission timer 138 and watchdog timer 140 based on commands received from master controller 160 and decoded by communications decoder 148. In one embodiment, tamper detect state machine 142 make decisions for activating data destruct engine 150 through an algorithm executed by tamper detection circuit 110.

Mission timer 138 is programmed to count down in time for a period equal to an intended mission duration. Once the intended mission duration is reached, mission timer 138 provides an end of mission signal to tamper detect state machine 142 to activate data destruct engine 150. In one embodiment, the intended mission duration for mission timer 138 is re-programmable. In such an embodiment, a command sequence received via communications decoder 148 is used to either reset mission timer 138 to restart counting for the original mission duration, or reprogram mission timer 138 to time a different mission duration.

Watchdog timer 140 functions to verify that memory device 110 remains in communication with master controller 160. In operation, watchdog timer 140 counts down from a predetermined watchdog duration. When tamper detection circuit 110 receives a watchdog reset command sequence from master controller 160, watchdog timer 140 resets back to the watchdog duration and begins to count down once again. In other words, as long as tamper detection circuit 110 periodically receives an expected watchdog reset command sequence, it presumes that communications with master controller 160 remain intact.

When tamper detection circuit 110 does not receive a watchdog reset prior to completing the countdown, watchdog timer 140 provides a loss of master signal to tamper detect state machine 142. Upon receiving the loss of master signal, tamper detection state machine 142 activates data destruct engine 150. In one embodiment, watchdog timer 140 is reprogrammable. In such an embodiment, a command sequence received via communications decoder 148 may be used reprogrammed watchdog timer 140 for either a longer or shorter watchdog duration. For example, a shorter watchdog duration might be appropriate when master controller 160 is performing certain critical activities, while a longer watchdog duration might be appropriate when master controller 160 is operating in a standby mode. In one embodiment, the watchdog reset command sequence rotates each cycle so that a valid watchdog reset command sequence for one watchdog timer iteration is not necessarily a valid watchdog reset command sequence for the next watchdog timer iteration. Rotating the watchdog reset command sequence provides one means to thwart an attack that attempts to mimic the watchdog reset command sequence. In one embodiment, each next valid watchdog resent command is communicated to communications decoder 148 by master controller 160 via an encrypted message.

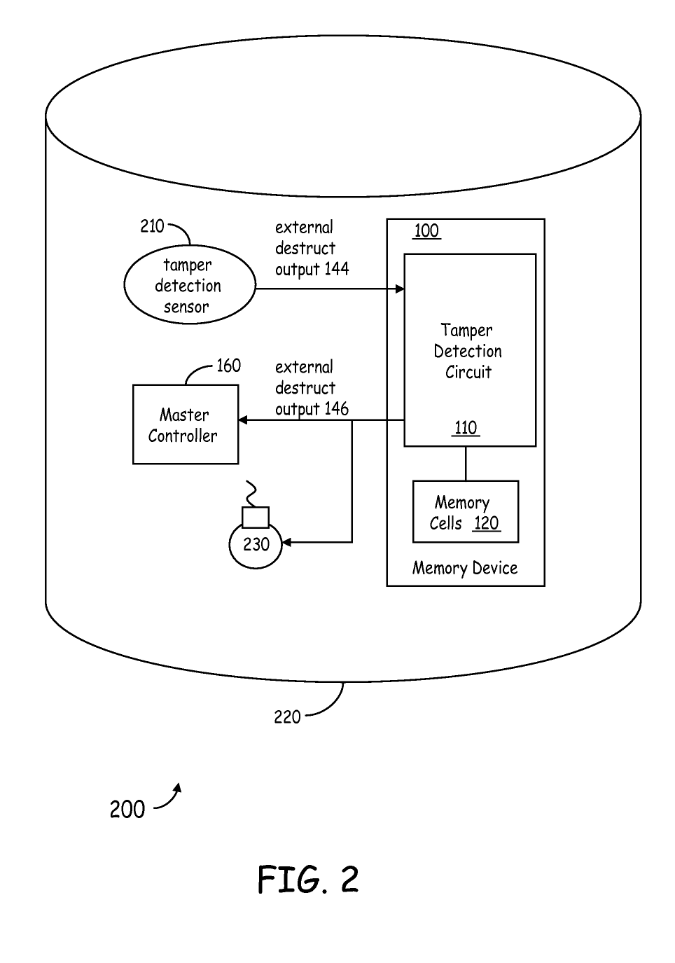

External destruct input 144 provides an input which allows master controller 160, or another external device coupled to external destruct input 144, to immediately instruct tamper detect state machine 142 to activate data destruct engine 150. For example, in one embodiment shown in FIG. 2, external destruct input 144 of a memory device 100 is connected to a tamper detection sensor 210 such as, but not limited to, a pressure monitor, temperature monitor, or light monitor. For example, in one embodiment, memory device 100 is housed within a pressurized container 220. If the container 220 is opened, causing a loss of internal pressure, tamper detection sensor 210 senses the depressurization and sends a signal to external destruct input 144 which in turn will activating data destruct engine 150.

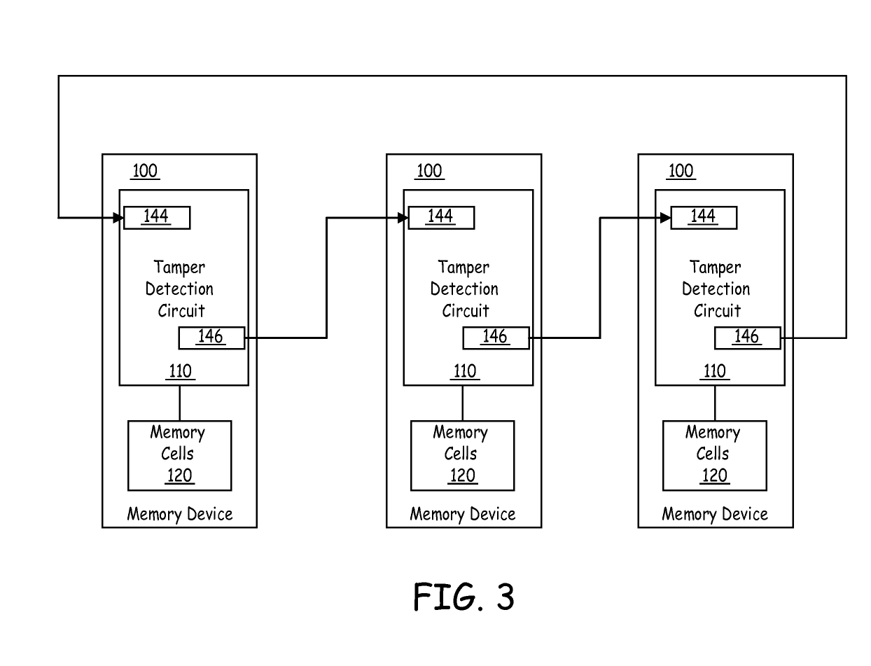

External destruct output 146 provides an interface which allows memory device 100 to notify external components that it has activated data destruct engine 150. For example, in the embodiment shown in FIG. 2, external destruct output 146 provides an alarm signal to master controller 160 when data destruct engine 150 is activated. FIG. 2 further illustrations another optional implementation wherein external destruct output 146 provides a signal to detonate an explosive 230 or initiate another physically destructive protection device to render the contents of container 220 neutralized. In another embodiment, illustrated in FIG. 3, an external destruct outputs 146 of a memory device 100 is coupled to a external destruct input 144 of another memory device 100. By daisy-chaining external destruct outputs 146 and inputs 144 as shown in FIG. 3, when one memory device 100 detects a tampering event, then it can initiate activation of data destruct engines of other the memory devices 100 to which it is coupled.

Communication decoder 148 provides an interface for externally communication with circuit 110. Communications decoder processes command messages generated by the master controller 160. The command messages may be optionally encrypted or non-encrypted. Communication decoder 148 monitors memory interface 152 looking for memory access sequences that it recognizes as one of a plurality of messages which are known to both master controller 160 and memory device 100. A memory access sequence can be either a sequence of memory write operations or a sequence of memory read operations. In one alternate embodiment, a memory access sequence would comprise a combination of both read and write operations.

For example, in one embodiment, communication decoder 148 recognizes that master controller 160 is sending a watchdog reset command sequence based on a sequence of memory write operations performed to predetermined addresses within memory cell 120 and comprising predetermined data values. In another embodiment, master controller 160 can alter the watchdog duration used by watchdog timer 140 by initiating a predetermined sequence of memory write operations that includes data representing a new watchdog duration value. Other commands may include, but are not limited to, resetting and reprogramming mission timer 138 and a self-destruct command. Further, in optional implementations, master controller 160 can issue command messages to enable or disable mission timer 138, watchdog timer 140, external destruct input 144 and external destruct output 146.

In the embodiment shown in FIG. 1, memory device 100 comprises a multi-chip module within an integrated circuit (IC) package. That is, tamper detection circuit 110 and memory cells 120 are both housed within the same IC package. To an external observer, memory device 100 thus appears as a common IC memory chip having pin-outs connections associated with memory interface 152. For embodiments including a external destruct input and output, one or more additional pin-outs are also provided.

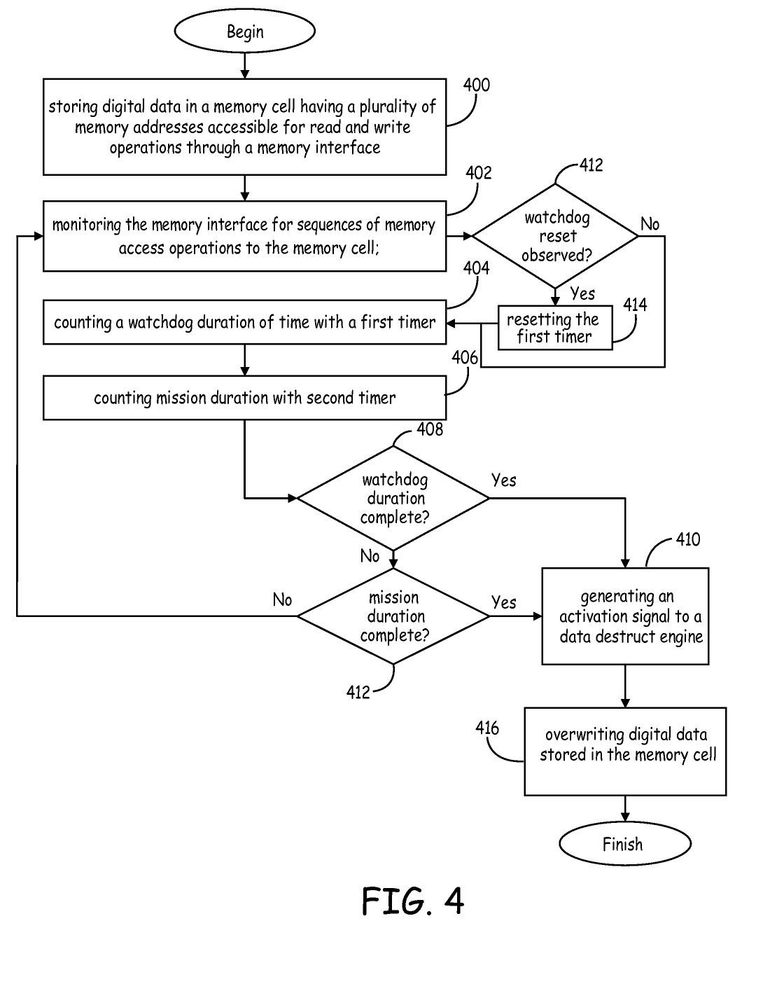

FIG. 4 is a flow chart illustrating a method for providing tamper resistant memory of one embodiment of the present invention. The method begins at 400 with storing digital data in a memory cell having a plurality of memory addresses accessible for read and write operations through a memory interface. The digital data may include, but is not limited to programming instruction code, code for an FPGA, algorithms, sampled sensor data, computational results, temporary buffer data, or any other type of data. In one embodiment, the memory interface includes address, data and control lines for providing read and write access to the memory cell. In one implementation, the address and data lines provide data access lines for saving digital data to specific memory addresses and retrieving data from specific memory addresses. A control line handles operational functions such as indicating whether a current memory request is a read or a write operation. One of ordinary skill in the art upon reading this specification would appreciate that embodiments of the present invention are not limited to a specific technology used to implement the memory cells but may include any technology such as RAM and EEPROMs that can be accessed in serial or parallel modes and allow read and write access to stored digital data.

The method proceeds to 402 with monitoring the memory interface for sequences of memory access operations to the memory cell. In one embodiment, the method looks for sequences of memory write operations which correspond to command messages generated by a master controller. In alternate embodiments, a memory access operation may be either a read or a write operation. The command messages may be either encrypted messages or non-encrypted messages. In one embodiment, such a command sequence comprises a sequence of memory write operations performed to predetermined addresses within the memory cell and comprising predetermined data values.

The method proceeds to 404 with counting a watchdog duration of time with a first timer. The first timer, operating as a watchdog timer, functions to verify that the memory device remains in communication with its master controller. In operation in one embodiment, the first (watchdog) timer counts down from the watchdog duration towards zero. In alternate embodiments, first timer counts up from zero toward the predetermined watchdog duration. When the first timer completes counting the watchdog duration (determined at 408) the method proceeds to 410 with generating an activation signal to a data destruct engine. When a watchdog reset command sequence is observed from monitoring the memory interface (determined at 412) the method proceeds to 414 with resetting the first timer. When a watchdog reset command sequence is received from the master controller, the watchdog timer resets back to the watchdog duration and begins to count down once again. In other words, as long as expected watchdog reset command sequence is periodically received within the watchdog duration, it may be presumed that communications with master controller remain intact. Otherwise, communication with the master controller is presumed lost and the data destruct engine is activated.

The method also proceeds to 406 with counting a mission duration with a second timer. In one embodiment, the second timer, operating as a mission timer, is programmed to count down in time towards zero for a period equal to an intended mission duration. In alternate embodiments, second (mission) timer counts up from zero toward the predetermined mission duration. Once the intended mission duration is reached, the second timer provides an end of mission signal to activate the data destruct engine. In one embodiment, the intended mission duration for the second timer is re-programmable using a command sequences received via the memory interface. When the second timer completes counting the mission duration (determined at 412) the method will also proceed to 410 with generating the activation signal to the data destruct engine. The method proceeds to 416 with overwriting digital data stored in the memory cell when the data destruct engine receives the activation signal.

In alternate embodiments, the data destruct engine overwrites some or all of the digital data stored in the memory cell by writing zero, ones or random data to the memory cell. In one embodiment, data destruct engine writes over the digital data with dummy data. That is, in one embodiment the data destruct engine replaces digital data stored in the memory cells with bogus data that is intended to mislead a tampering party. For example, in one embodiment, instruction code stored in memory cells is replaced with bogus instruction code. In another embodiment, the data destruct engine replaces actual sensor measurement data with erroneous data that appears to be sensor measurement data. In one embodiment, rather that obliterating all digital data from the memory cell, block 416 performs a targeted overwrite, only targeting certain areas (memory addresses) of the memory cell. In one embodiment, block 416 overwrites data based on a priority lists, erasing the most sensitive data first before proceeding to relatively less sensitive data.

Several means are available to implement components of the tamper detection circuits, systems and methods of the current invention as discussed in this specification. In addition to any means discussed above, these means include, but are not limited to, digital micro processors, controllers, state machines or similar processing devices. Therefore other embodiments of the present invention are program instructions resident on computer readable media which when implemented by such controllers, implement embodiments of the present invention. Computer readable media are physical devices which include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A memory device, the device comprising:
a memory cell for storing digital data, the memory cell having a plurality of memory addresses accessible for read and write operations through a memory interface; and
a tamper detection circuit coupled to the memory cell, the tamper detection circuit comprising:
a communications decoder coupled to the memory interface, wherein the communications decoder observes sequences of memory access operations to the memory cell;
at least one timer for counting a duration of time;
a tamper detect state machine responsive to the communications decoder and the at least one timer; and
a data destruct engine responsive to the tamper detection state machine, wherein upon receiving an activation signal from the tamper diction state machine, the data destruct engine overwrites digital data stored in the memory cell.

2. The device of claim 1, wherein the data destruct engine overwrites digital data with one or both of bogus code and bogus data.

3. The device of claim 1, wherein the data destruct engine overwrites targeted memory addresses of the memory cell in a prioritized order.

4. The device of claim 1, wherein the at least one timer comprises a watchdog timer, wherein when the communications decoder observes a watchdog reset command sequence, the tamper detection state machine resets the watchdog timer.

5. The device of claim 4, where when the watchdog timer completes timing a watchdog duration without being reset, the watchdog timer provides a loss of master signal to the tamper detect state machine that activates the data destruct machine.

6. The device of claim 1, wherein the at least one timer comprises a mission timer, where when the mission timer completes timing a mission duration, the mission timer provides an end of mission signal to the tamper detect state machine that activates the data destruct engine.

7. The device of claim 1, wherein the tamper detect state machine reconfigures the duration of the at least one time based on a command recognized by the communications decoder from a sequences of memory access operations.

8. The device of claim 1, wherein the tamper detect state machine activates the data destruct engine based on a command recognized by the communications decoder from a sequences of memory access operations.

9. The device of claim 1, the tamper detection circuit further comprising an external destruct input coupled to the tamper detect state machine, wherein when the external destruct input receives an external destruct signal, the tamper detect state machine activates the data destruct engine.

10. The device of claim 1, the tamper detection circuit further comprising an external destruct output coupled to the tamper detect state machine, wherein when the tamper detect state machine activates the data destruct engine, the external destruct output transmits a signal.

11. A system comprising:
a controller; and
at least one memory device coupled to the controller through a memory interface, the at least one memory device having a memory cell for storing digital data, the memory cell having a plurality of memory addresses accessible to the controller for read and write operations through the memory interface, the at least one memory device further comprising:
a communications decoder coupled to the memory interface, wherein the communications decoder observes sequences of memory access operations to the memory cell;
at least one timer for counting a duration of time;
a tamper detect state machine responsive to the communications decoder and the at least one timer; and
a data destruct engine responsive to the tamper detection state machine, wherein upon receiving an activation signal from the tamper diction state machine, the data destruct engine overwrites digital data stored in the memory cell.

12. The system of claim 11, wherein the at least one timer comprises a watchdog timer, wherein when the communications decoder observes a watchdog reset command sequence, the tamper detection state machine resets the watchdog timer; and
wherein when the watchdog timer completes timing a watchdog duration without being reset, the watchdog timer provides a loss of master signal to the tamper detect state machine that activates the data destruct machine.

13. The system of claim 11, wherein the at least one timer comprises a mission timer, where when the mission timer completes timing a mission duration, the mission timer provides an end of mission signal to the tamper detect state machine that activates the data destruct engine.

14. The system of claim 11, wherein the tamper detect state machine reconfigures the at least one timer based on a command recognized by the communications decoder from a sequences of memory access operations.

15. The system of claim 11, the at least one memory device further comprising an external destruct input coupled to the tamper detect state machine and an external destruct output coupled to the tamper detect state machine;
wherein when the external destruct input receives an external destruct signal, the tamper detect state machine activates the data destruct engine; and
wherein when the tamper detect state machine activates the data destruct engine, the external destruct output transmits a signal.

16. The system of claim 15 wherein the at least one memory device comprises a first memory device and a second memory device, wherein an external destruct output of the first memory devices is coupled to an external destruct input of the second memory device.

17. A method for protecting data stored in a memory device from tampering, the method comprising:
storing digital data in a memory cell having a plurality of memory addresses accessible for read and write operations through a memory interface;
monitoring the memory interface for sequences of memory access operations to the memory cell;
counting a watchdog duration of time with a first timer;
counting a mission duration with a second timer;
when the first timer completes counting the watchdog duration generating an activation signal to a data destruct engine;
when the second timer completes counting the mission duration generating the activation signal to the data destruct engine;
when a watchdog reset command sequence is observed from monitoring the memory interface, resetting the first timer; and
when the data destruct engine receives the activation signal, overwriting digital data stored in the memory cell.

18. The method of claim 17, further comprising overwriting the digital data with one or both of bogus code and bogus data.

19. The method of claim 17, further comprising overwriting targeted memory addresses of the memory cell in a prioritized order.

20. The method of claim 17, further comprising overwriting digital data stored in the memory cell when an externally generated destruct signal is received by an external input.
